(19) United States
(12) Patent Application Publication
(10) Pub. No.: US 2025/0068557 A1
(43) Pub. Date: Feb. 27, 2025

(54) MEMORY ALLOCATING METHOD, ELECTRONIC DEVICE, AND STORAGE MEDIUM

(71) Applicant: Beijing Volcano Engine Technology Co., Ltd., Beijing (CN)

(72) Inventors: Yifei ZHANG, Beijing (CN); Chuansheng LU, Beijing (CN); Xiangdong JI, Beijing (CN); Deyu WANG, Beijing (CN)

(21) Appl. No.: 18/793,741

(22) Filed: Aug. 2, 2024

(30) Foreign Application Priority Data
Aug. 25, 2023 (CN) 202311085520.2

(51) Int. Cl. G06F 12/02

(52) U.S. Cl. CPC G06F 12/023

(57) ABSTRACT

The embodiments of the present disclosure provide a memory allocating method, an electronic device, and a computer-readable storage medium. The method includes: allocating a first memory space of a preset size to a first thread to be allocated memory, and configuring a first bitmap having a mapping relationship with the first memory space; consecutively allocating memory in the first memory space according to a size of each of objects to be allocated memory in the first thread, and identifying a memory starting address of each of the objects in the first bitmap based on the mapping relationship.

### CROSS-REFERENCE TO RELATED APPLICATION

This application claims the priority to and benefits of the Chinese Patent Application No. 202311085520.2, filed on Aug. 25, 2023, the entire disclosure of which is incorporated herein by reference as part of the disclosure of this application.

### TECHNICAL FIELD

The embodiments of the present disclosure relate to the technical field of computer and network communication, in particular to a memory allocating method, device and storage medium.

### BACKGROUND

Memory management, which is an important constituent part of a system at runtime of a program, is mainly responsible for memory allocation and recovery at the runtime. Within the program, an overwhelming majority of requests for memory allocation come from object allocation in the program, that is, allocating corresponding memory space for objects. Since the object allocation is a very frequent operation, the performance of object allocation greatly affects the performance of the program.

The form of memory management determines the form and efficiency of object allocation, however, the performance of object allocation in the prior art is not high.

### SUMMARY

The embodiments of the present disclosure provide a memory allocating method, device, and storage medium to improve the performance of object allocation.

In the first aspect, the embodiments of the present disclosure provide a memory allocating method, which includes:
allocating a first memory space of a preset size to a first thread to be allocated memory, and configuring a first bitmap having a mapping relationship with the first memory space; and
consecutively allocating memory in the first memory space according to a size of each of objects to be allocated memory in the first thread, and identifying a memory starting address of each of the objects in the first bitmap based on the mapping relationship.

In the second aspect, the embodiments of the present disclosure provide a memory allocating device, which includes an allocating unit and a processing unit.

The allocating unit is configured to allocate a first memory space of a preset size to a first thread to be allocated memory, and configure a first bitmap having a mapping relationship with the first memory space.

The processing unit is configured to consecutively allocate memory in the first memory space according to a size of each of objects to be allocated memory in the first thread, and identify a memory starting address of each of the objects in the first bitmap based on the mapping relationship.

In the third aspect, the embodiments of the present disclosure provide an electronic device, which include: at least one processor and a memory.

The memory stores computer-executable instructions; and
the at least one processor executes the computer-executable instructions stored in the memory, causing the at least one processor to perform the memory allocating method in the first aspect.

In the fourth aspect, the embodiments of the present disclosure provide a computer-readable storage medium, and computer-executable instructions are stored in the computer readable storage medium. The computer-executable instructions, when executed by a processor, cause the processor to perform the memory allocating method in the first aspect.

In the fifth aspect, the embodiments of the present disclosure provide a computer program product which includes computer-executable instructions. The computer-executable instructions, when executed by a processor, cause the processor to perform the memory allocating method in the first aspect.

### BRIEF DESCRIPTION OF DRAWINGS

In order to describe the technical schemes of the embodiments of the present disclosure and in the prior art more clearly, the drawings which are used in the description of the technical schemes in the embodiments and in the prior art are described below. Obviously, the drawings in the following description are some embodiments of the present disclosure, and other drawings can be obtained according to these drawings without creative efforts for a person of ordinary skill in the art.

FIG. 1a is an example diagram of a memory allocating method in the prior art;

FIG. 1b is an example diagram of another memory allocating method in the prior art;

FIG. 2 is a schematic diagram of a memory allocating method provided by an embodiment of the present disclosure;

FIG. 3 is a flow schematic diagram of a memory allocating method provided by an embodiment of the present disclosure;

FIG. 4 is a schematic diagram of a memory allocating method provided by another embodiment of the present disclosure;

FIG. 5 is a schematic diagram of a memory allocating method provided by another embodiment of the present disclosure;

FIGS. 6a-d are schematic diagrams for determining metadata of target object provided by an embodiment of the present disclosure;

FIG. 7 is a structural block diagram of a memory allocating device provided by an embodiment of the present disclosure; and

FIG. 8 is a schematic diagram of hardware structure of an electronic device provided by an embodiment of the present disclosure.

### DETAILED DESCRIPTION

To make the objectives, technical solutions, and advantages of the embodiments of the present disclosure more clear, the following clearly and completely describes the technical solutions in the embodiments of the present disclosure with reference to the accompanying drawings in the embodiments of the present disclosure. Apparently, the described embodiments are some but not all of the embodiments of the present disclosure. All other embodiments acquired by a person of ordinary skill in the art based on the embodiments of the present disclosure without creative efforts should fall within the protection scope of the present disclosure.

The form of memory management determines the form and efficiency of object allocation.

For example, an implementation of allocation by a block memory allocator is to: allocate a large block of memory to the operating system, and then divide the large block of memory into different groups, in which different groups are to be allocated different sizes of objects, and the memory within the same group is divided into equally-sized memory blocks. Meanwhile, the system for memory management records the metadata of each group of memory, such as the starting and ending addresses of the group, the size of the allocated object, etc.

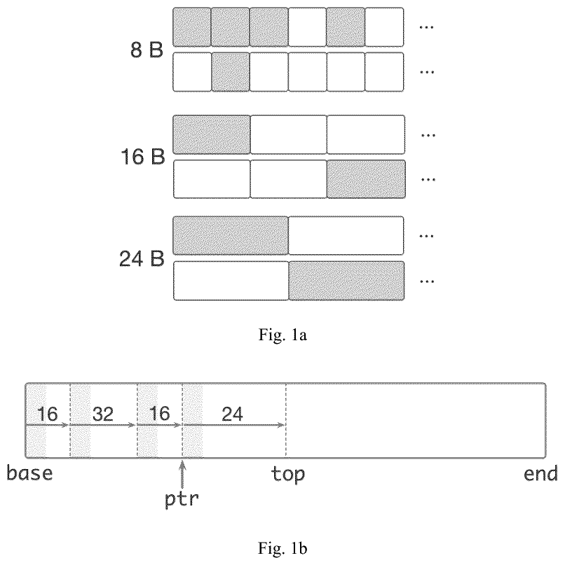

As illustrated in FIG. 1a, the memory obtained from the operating system is divided into three groups, which are to be allocated objects of 8 B, 16 B and 24 B respectively. The memory of each group is divided into equally-sized memory blocks, in which gray indicates already allocated memory blocks and white indicates idle memory blocks. When a program needs to allocate an object, it first acquires the size of the object; find a corresponding memory group according to the size, get an idle block therefrom, and then return the starting address of the idle block, thus completing an object allocation.

The advantage of this implementation of allocation is that: by combining a pointer pointing to an object and metadata of a memory group, the metadata of the object, such as the starting and ending addresses of the object and the size of the object, can be acquired, which is convenient for memory management. Meanwhile, since the metadata of the object is determined at allocation, it is not required to determine the type of the object from the type of the pointer. This form of memory management also brings degree of freedom to the language. The language can support pointer operation, such as converting a pointer pointing to an object into a pointer pointing to one of the domains through pointer operation, so that a more efficient program can be written. However, the disadvantage of this implementation of allocation is also evident. Since there are many operations for allocating an object, such as searching for a corresponding memory group according to the object's size, and then searching for an idle block in the memory group, the efficiency in the object allocation is not high.

In addition, another memory allocator focuses on more efficient object allocation. The allocator may allocate a relatively large object allocation buffer to each thread, and allocate objects consecutively therein. As illustrated in FIG. 1b, base and end represent the starting address and the ending address of this object allocation buffer, respectively; top represents the currently used location, to the left side of top is the allocated memory, to the right side of top is the memory to be allocated, the dotted line represents the dividing line for object, and ptr is the pointer pointing to an object. It is very efficient to allocate objects in such an object allocation buffer. According to a size s of an object, the pointer top is moved to the position of top+s, and the address of top before the movement is returned, thus completing the allocation. Therefore, such memory allocator may allocate objects of various sizes consecutively in an object allocation buffer. In such scenario, additional memory may be allocated at a starting position of an object to save the metadata of the object. In FIG. 1b, the gray part at a starting position of an object represents the metadata saved on the object. Meanwhile, a pointer pointing to an object can only point to a specific location of the object, so that the metadata of the object can be acquired accurately. The disadvantage of this implementation is that: it requires additional space to store metadata of objects, and also requires a pointer to point to a specific location of an object (pointing to the memory starting address of the object), and does not support pointer operation.

In order to solve the above technical problems, the present disclosure provides a memory allocating method, including: allocating a first memory space of a preset size to a first thread to be allocated memory, and configuring a first bitmap having a mapping relationship with the first memory space, as illustrated in FIG. 2, for example; consecutively allocating memory in the first memory space according to a size of each of objects to be allocated memory in the first thread, and identifying a memory starting address of each of the objects in the first bitmap based on the mapping relationship. As a result, by consecutively allocating memory for each of the objects to be allocated memory in the first memory space, the performance of object allocation can be improved, which is beneficial to continuous access to the objects; without requiring additional allocation of memory at object starting position to save metadata of the objects, the memory overhead can be saved, which improves the performance of accessing memory by program; by utilizing a more compact bitmap to store the information on the memory starting address for the objects, the metadata of the object can be quickly determined; and since the memory for the objects is continuous and there no metadata of the objects in the memory, the pointer can point to any position in the memory for the objects, thus supporting pointer operation, and guaranteeing the efficiency and conciseness of the codes.

The memory allocating method of the present disclosure will be described in detail in connection with specific embodiments.

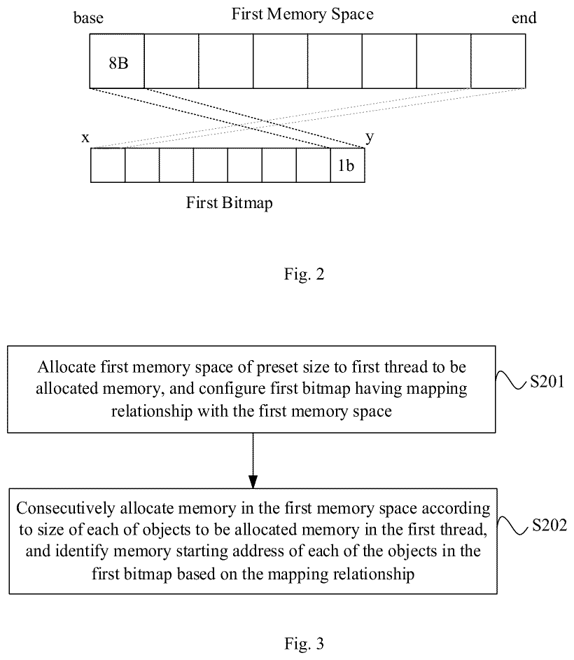

Referring to FIG. 3, FIG. 3 is a flow schematic diagram of a memory allocating method provided by an embodiment of the present disclosure. The method of this embodiment can be applied to a terminal device or a server, and the memory allocating method includes:

S201: allocating a first memory space of a preset size to a first thread to be allocated memory, and configuring a first bitmap having a mapping relationship with the first memory space.

In this embodiment, for the first thread whose program objects are allocated memory consecutively, when the memory for each object in the first thread needs to be allocated, a first memory space (or buffer) of a preset size may be allocated to the first thread. The first memory space may be a relatively large memory space, whose preset size may be, for example, 1 KB. The objects of the first thread may be allocated memory consecutively in the first memory space.

In order for the convenience of determining the metadata of each object, that is, object memory related information, including the memory starting address, memory ending address, memory size, etc., and in order to require no metadata to be stored in the memory together with the object and to be able to support pointer operation, in this embodiment, a bitmap having a mapping relationship with the first memory space, which is denoted as a first bitmap, is additionally configured. The smallest unit of the bitmap is a bit, which may be configured as a value of 1 or 0. The initial value of the first bitmap is 0. The mapping relationship is to map the first memory space into the first bitmap, especially to map a space of a specific size in the first memory space into the first bitmap, so as to reflect the storage situation of the first memory space with the first bitmap. The mapping relationship may be any mapping relationship, as long as the space of a specific size in the first memory space can be mapped into the first bitmap. For example, the mapping can be a sequential correspondence or a correspondence in a specified order.

Optionally, the mapping relationship is that: each bit in the first bitmap corresponds to a preset number n of bytes in the memory space sequentially. For example, every 8 bytes in the first memory space corresponds to one bit in the first bitmap, and if the first memory space is 1 KB, the size of the first bitmap is 1 KB/8=128 bit=16B, that is, there are 128 first bits in the first bitmap, occupying a space of 16 bytes.

In the first alternative embodiment, the correspondence between the first memory space and the first bitmap can be illustrated in FIG. 2, where the first n bytes in the first memory space are aligned with the last bit in the first bitmap, the second n bytes in the first memory space are aligned with the penultimate bit in the first bitmap, and so on, and the last n bytes in the first memory space are aligned with the first bit in the first bitmap. That is, in FIG. 2, the head (starting position base) of the first memory space is on the left and the tail (ending position end) of the first memory space is on the right, whereas the head of the first bitmap is on the right and the tail of the first bitmap are on the left.

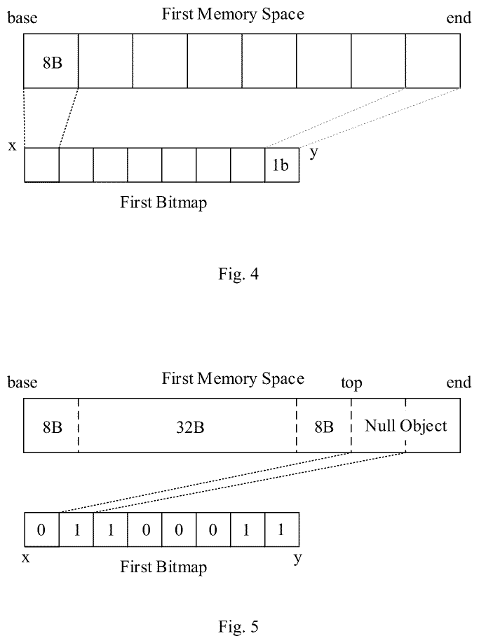

In the second alternative embodiment, the correspondence between the first memory space and the first bitmap can be illustrated in FIG. 4, where the first n bytes in the first memory space are aligned with the first bit in the first bitmap, the second n bytes of the first memory space are aligned with the second bit in the first bitmap, and so on, and the last n bytes in the first memory space are aligned with the last bit in the first bitmap. That is, in FIG. 4, the head (starting position base) of the first memory space is on the left and the tail (ending position end) of the first memory space is on the right, whereas the head of the first bitmap is on the left and the tail of the first bitmap is on the right.

In the following embodiments, the first alternative embodiment is taken as an example for illustration, and the second alternative embodiment is similar to the first alternative embodiment, except for some adaptive variations, and will not be detailed here. Of course, the mapping relationship in this example is not limited to the above example, and other mapping relationships are also possible.

S202: consecutively allocating memory in the first memory space according to a size of each of objects to be allocated memory in the first thread, and identifying a memory starting address of each of the objects in the first bitmap based on the mapping relationship.

In this embodiment, the memory is consecutively allocated in the first memory space according to the size of each object to be allocated memory in the first thread, so that a continuous allocation of memory can be realized, and the size of memory allocated to each object is the same as or greater than the size of the object.

In this embodiment, rather than requiring to store metadata (including memory starting address, memory ending address, memory size, etc.) of objects in the memory, the memory starting address of each object is identified in the first bitmap by utilizing the mapping relationship between the first memory space and the first bitmap.

Especially, based on the mapping relationship, the first memory space can be aligned with the bits in the first bitmap. In turn, the corresponding bit of each object's memory starting address in the first bitmap can be determined also based on the mapping relationship, in which the bit may be set to 1. Subsequently, the memory starting address of each object can be derived based on the bits with a value of 1. Due to the continuous memory allocation of objects, the memory ending address of each object can also be derived, and in turn, the object size can also be determined.

This embodiment provides a memory allocating method, including: allocating a first memory space of a preset size to a first thread to be allocated memory, and configuring a first bitmap having a mapping relationship with the first memory space; consecutively allocating memory in the first memory space according to a size of each of objects to be allocated memory in the first thread, and identifying a memory starting address of each of the objects in the first bitmap based on the mapping relationship. As a result, by consecutively allocating memory for each of the objects to be allocated memory in the first memory space, the performance of object allocation can be improved, which is beneficial to continuous access to the objects; without requiring additional allocation of memory at object starting position to save metadata of the objects, the memory overhead can be saved, which improves the performance of accessing memory by program; and by utilizing a more compact bitmap to store the information on the memory starting address for the objects, the metadata of the object can be quickly determined, and the pointer can point to any position in the memory for the objects, thus supporting pointer operation, and guaranteeing the efficiency and conciseness of the codes.

On the basis of the above embodiment, if the mapping relationship between the first memory space and the first bitmap is that each bit in the first bitmap sequentially corresponds to a preset number of bytes in the first memory space, S202, on the basis thereof, specifically includes:
clearing all bits of the first bitmap to zero;
consecutively allocating memory in the first memory space according to the size of each of the objects to be allocated memory in the first thread, in which a memory size of each object is a multiple of the preset number;
setting a bit in the first bitmap corresponding to the memory starting address of each of the objects to 1.

In this embodiment, either before allocating memory to the objects of the first thread for the first time in the first memory space, or when configuring the first bitmap having a mapping relationship with the first memory space, all bits of the first bitmap may be cleared to zero, so as to avoid affecting the subsequent identification process.

When allocating memory to any one of the objects, the allocated memory to each object is a multiple (including 1 time, 2 times, etc.) of the preset number n, and the starting address of the object in the first memory space can be determined. The starting addresses of all objects are multiples of the preset number n. For example, if n is 8, the starting addresses of all objects are multiples of 8, so that the corresponding bits in the first bitmap can be determined according to the starting addresses of the objects, and the bits can be set to 1, indicating the memory starting addresses corresponding to the bits.

When determining a corresponding bit in the first bitmap according to the memory starting address of the object, the byte in the first bitmap where the bit corresponding to the memory starting address of the object is located can be determined. Specifically, the memory starting address of the object may be subtracted by the starting address of the first memory space, and then divided by n, so that the corresponding m-th bit in the first bitmap (i.e., the offset in the first bitmap) of the memory starting address is determined, and the byte where the bit is located in the first bitmap is the m/8-th Byte (8 bits=1 byte). The address of the byte where the bit corresponding to the memory starting address of the object is at may be located by adding m/8 to the starting address of the first bitmap, and in this byte, the bit corresponding to the memory starting address of the object may be set to 1 by means of bit operation.

Of course, the implementation of identifying the memory starting address of each object in the first bitmap is not limited to the above example, and other implementations can be employed.

On the basis of any of the above embodiments, the consecutively allocating memory in the first memory space according to the size of each of the objects to be allocated memory in the first thread, may specifically include:
determining, before allocating memory to any one of the objects, whether the unused memory of the first memory space meets the size of the object;
allocating, if the unused memory of the first memory space meets the size of the object, memory from the starting address of the unused memory according to the size of the object.

In this embodiment, since a first memory space of a preset size has been allocated to the first thread, the first memory space is limited, and multiple objects to be allocated memory are present in the first thread, there may be a situation where the first memory space is full. Before allocating memory to any object to be allocated memory, firstly, it is judged whether the unused memory of the first memory space meets the size of the object, and if so, it means that the unused memory in the first memory space is sufficient, and the object may be continued to be allocated memory in the first memory space, that is, the memory is allocated from the starting address of the unused memory according to the size of the object.

To judge whether the unused memory of the first memory space meets the size of the object, the starting address of the unused memory of the first memory space may be added with the size of the object, then it may be judged whether the result of the addition exceeds the ending address of the first memory space, and if so, it means that the unused memory of the first memory space does not meet the size of the object.

As illustrated in FIG. 5, if the unused memory in the first memory space does not meet the size of the object, a bit in the first bitmap corresponding to the starting address of the unused memory is set to 1. That is, the unused memory is taken as a null object, and the bit in the first bitmap corresponding to the memory starting address of the null object is set to 1 (to be a boundary with the previous object in the first bitmap). The unused memory is discarded, and a second memory space of a preset size is allocated (in which the size of the second memory space may either be equal to or larger or smaller than the size of the first memory space, optionally incrementing according to a certain rule). A second bitmap having a mapping relationship with the second memory space is configured (in which the mapping relationship between the second memory space and the second bitmap may be the same as or different from that in the above embodiment). The memory is consecutively allocated in the second memory space according to the size of each of the objects to be allocated memory in the first thread, and a memory starting address of each of the objects is identified in the second bitmap based on the mapping relationship, the process of which is the same as the above embodiment, and will not be detailed here. Likewise, for the second memory space and the second bitmap, other processes as described below are also the same as those for the first memory space and the first bitmap, and the other processes as described below are illustrated by taking only the first memory space and the first bitmap as examples.

On the basis of any of the above embodiments, the above-described memory allocating method supports pointer operations, including but not limited to arithmetic operations of pointers (such as addition and subtraction) and relational operations (such as comparing sizes of two pointers, and determining whether both are equal). A pointer can point to any position in the memory for the objects, so it is required to determine the metadata of the pointed object based on the pointer, including but not limited to at least one of a memory starting address, a memory ending address and a memory size of the object, the specific process of which includes as follows:
determining an address of a pointer pointing into a memory range of any target object in the first memory space;
determining metadata of the target object according to the address of the pointer and the first bitmap.

In this embodiment, if a certain pointer points into a memory range of any target object in the first memory space, including a memory starting address, a memory ending address, or any address between the memory starting address and the memory ending address of the target object, the address to which the pointer pointes, i.e., the address of the pointer, can be determined first. Since the first bitmap contains information on starting addresses of respective objects, the target object can be specified based on the address of the pointer, and then the metadata of the target object can be inferred in connection with the first bitmap, including but not limited to at least one of the memory starting address, memory ending address and memory size of the target object.

Specifically, the determining metadata of the target object according to the address of the pointer and the first bitmap may include:
firstly, determining a first bit in the first bitmap corresponding to the address of the pointer.

In this embodiment, since every preset number n of bytes in the first memory space corresponds to a bit in the first bitmap, when determining the bit in the first bitmap corresponding to the address of the pointer (denoted as a first bit), it is only required to determine the bit in the first bitmap corresponding to the first byte of the n bytes where the pointer is located. The address of the first byte of the n bytes where the pointer is located may be derived by clearing the lower log₂n bits of the address of the pointer to zero. Assuming that the preset number n is 8, the lower 3 bits of the address of the pointer are cleared to get the address of the first byte of the n bytes where the pointer is located, and in turn, the bit in the first bitmap corresponding to the first byte of the n bytes where the pointer is located is determined as the first bit in the first bitmap corresponding to the address of the pointer. Specifically, the position of the first bit in the first bitmap may be=(“address of first byte of n bytes where pointer is located”−“starting address of first memory space”)/n, or (“address of pointer”−“starting address of first memory space”)/n, and then be rounded.

Further, the processes of determining the memory starting address of the target object, determining the memory ending address of the target object and determining the memory size of the target object are as follows, respectively.

The process of determining the memory starting address of the target object includes as follows:
searching for a second bit with a value of 1 that is nearest to the first bit in the head direction in the first bitmap, and determining a first offset between the first bit and the second bit, and determining a first memory offset between the memory starting address of the target object and the address of the pointer according to the first offset and the preset number; determining the memory starting address of the target object according to the address of the pointer and the first memory offset.

In this embodiment, after determining the first bit in the first bitmap corresponding to the address of the pointer, a second bit with a value of 1 that is nearest to the first bit is searched for in the head direction in the first bitmap. The second bit corresponds to the memory starting address of the target object. For FIG. 2 in the above embodiment, the head direction is the right side direction, that is, the second bit with a value of 1 that is nearest to the first bit is searched for on the right side of the first bit in the first bitmap; whereas for FIG. 4, the head direction is the left side direction, that is, the second bit with a value of 1 that is nearest to the first bit is searched for on the left side of the first bit in the first bitmap.

The first offset between the first bit and the second bit, that is, the number of bits present between the first bit and the second bit, may be acquired, and correspondingly, the number of bytes present between the memory starting address of the target object and the address of the pointer (the address of the first byte of the n bytes where the pointer is located) in the first memory space=“first offset”×“preset number n”, that is, a first memory offset, may be determined. According to the address of the pointer and the first memory offset, the memory starting address of the target object may be determined. Specifically, the memory starting address of the target object=“address of first byte of n bytes where pointer is located”−“first memory offset”.

The process of determining the memory ending address of the target object includes as follows:
searching for a third bit with a value of 1 that is nearest to the first bit in the tail direction in the first bitmap, and determining a second offset between the first bit and the third bit, and determining a second memory offset between the starting address of the target object and the ending address of the pointer according to the second offset and the preset number; determining the memory ending address of the target object according to the address of the pointer and the second memory offset.

In this embodiment, similar to the above-described process of determining the memory starting address of the target object, after determining the first bit in the first bitmap corresponding to the address of the pointer, a third bit with a value of 1 that is nearest to the first bit is searched for in the tail direction in the first bitmap. The third bit corresponds to the memory starting address of the next object adjacent to the target object, and is also the memory ending address of the target object. For FIG. 2 in the above-described embodiment, the tail direction is the left side direction, that is, the third bit with a value of 1 that is nearest to the first bit is searched for on the left side of the first bit in the first bitmap; whereas for FIG. 4, the tail direction is the right side direction, that is, the third bit with a value of 1 that is nearest to the first bit is searched for on the right side of the first bit in the first bitmap.

The second offset between the first bit and the third bit, that is, the number of bits present between the first bit and the third bit, may be acquired, and correspondingly, the number of bytes present between the ending address of the target object and the address of the pointer (the address of the first byte of the n bytes where the pointer is located) in the first memory space=“second offset”×“preset number n”, that is, a second memory offset, may be determined. According to the address of the pointer and the second memory offset, the memory ending address of the target object may be determined. Specifically, the memory ending address of the target object=“address of first byte of n bytes where pointer is located”+“second memory offset”.

The process of determining the memory size of the target object includes as follows:
determining the memory size of the target object according to the memory starting address of the target object and the memory ending address of the target object.

On the basis of the above embodiment, the determining a first bit in the first bitmap corresponding to the address of the pointer, includes:
determining a byte where the first bit is located in the first bitmap, reading a first partial bitmap correspond to the byte, and determining the first bit in the first partial bitmap.

In this embodiment, since the first bitmap may be relatively large, when determining the metadata of the target object according to the first bitmap, it is not required to read the entire first bitmap, but only to read one byte (denoted as a first partial bitmap) where the first bit is located in the first bitmap. The first partial bitmap includes 8 bits (1 byte=8 bits). The first bit is determined in the first partial bitmap, and the subsequent search for the second bit and the third bit are performed based on the first bit.

To determine the byte where the first bit is located in the first bitmap, firstly, which bit the first bit is in the entire first bitmap may be determined, the specific process of which is described in the above embodiment, that is, it is only required to determine the bit in the first bitmap corresponding to the first byte of the n bytes where the pointer is located. The position of the first bit in the first bitmap=(“address of first byte of n bytes where pointer is located”−“starting address of first memory space”)/n. Further, since every 8 bits in the first bitmap is a byte, the address of the byte where the first bit is located in the first bitmap=“starting address of first bitmap”+(“position of first bit in first bitmap”/8) may be determined. In turn, the byte is read from the first bitmap according to the address of the byte where the first bit is located in the first bitmap, so as to get the first partial bitmap.

The position of the first bit in the first partial bitmap is “position of first bit in first bitmap” %8 (i.e., mod 8).

Further, the searching for a second bit with a value of 1 that is nearest to the first bit in the head direction in the first bitmap, and determining a first offset between the first bit and the second bit, may specifically include:
determining a third offset for the first bit relative to the tail of the first partial bitmap;
determining whether the second bit exists in the first partial bitmap;
determining, if it is determined that the second bit exists in the first partial bitmap,
a fourth offset for the second bit relative to the tail of the first partial bitmap; determining the first offset between the first bit and the second bit according to the third offset and the fourth offset; or
reading, if it is determined that the second bit does not exist in the first partial bitmap, a part of the bitmap corresponding to a neighboring byte sequentially along the head direction, until a second partial bitmap where the second bit exists is found, and determining a fifth offset for the second bit relative to the tail of the second partial bitmap; determining a sixth offset for the second bit relative to the tail of the first partial bitmap according to the fifth offset; determining a first offset between the first bit and the second bit according to the third offset and the sixth offset.

In this embodiment, after determining the first bit in the first partial bitmap, a third offset for the first bit relative to the tail of the first partial bitmap, that is, the number of bits present between the first bit and the tail of the first partial bitmap, may be determined, in which the concepts of the head and tail of the first partial bitmap are the same as those in the above embodiment.

In addition, considering that the memory of the object may be relatively large, spanning multiple bytes in the first bitmap, since the first partial bitmap is only one byte of the first bitmap, the second bit in the head direction of the first bit in the first bitmap may be or may not be in the first partial bitmap. Therefore, it is further required to judge whether the second bit exists in the first partial bitmap. If it is determined that the second bit exists in the first partial bitmap, a fourth offset for the second bit relative to the tail of the first partial bitmap, that is, the number of bits present between the second bit and the tail of the first partial bitmap, may be determined. The first offset between the first bit and the second bit may be derived by subtracting the third offset from the fourth offset. If it is determined that the second bit does not exist in the first partial bitmap, a part of the bitmap corresponding to an adjacent byte is read sequentially along the head direction. Likewise, it is required to judge whether the second bit exists in the part of the bitmap corresponding to the adjacent byte sequentially. If the second bit does not exist in the part of the bitmap corresponding to the first adjacent byte, a part of the bitmap corresponding to the next adjacent byte is continued to be read, and so on, until the part of the bitmap (denoted as a second partial bitmap) where the second bit exist is found. Then, a fifth offset for the second bit relative to the tail of the second partial bitmap may be further determined. Since the third offset takes the tail of the first partial bitmap as reference, and the fifth offset takes the tail of the second partial bitmap as reference, it is required to make a conversion to cause the fifth offset to take the tail of the first partial bitmap as reference, so that a sixth offset for the second bit relative to the tail of the first partial bitmap is derived. As such, the first offset between the first bit and the second bit may be derived by subtracting the third offset from the sixth offset. Specifically, when determining the sixth offset, the number of bits between the tail of the second partial bitmap and the tail of the first partial bitmap may be acquired, and the fifth offset may be added to the number of bits to get the sixth offset.

On the basis of the above embodiment, the above process of determining the offset can be realized by means of bit operation, the specific process of which is as follows.

The first bit is determined in the first partial bitmap, and a first mask may be constructed according to the position of the first bit in the first partial bitmap. The length of the first mask is the same as that of the first partial bitmap, and the position corresponding to the first bit is 1, and the remaining positions are 0.

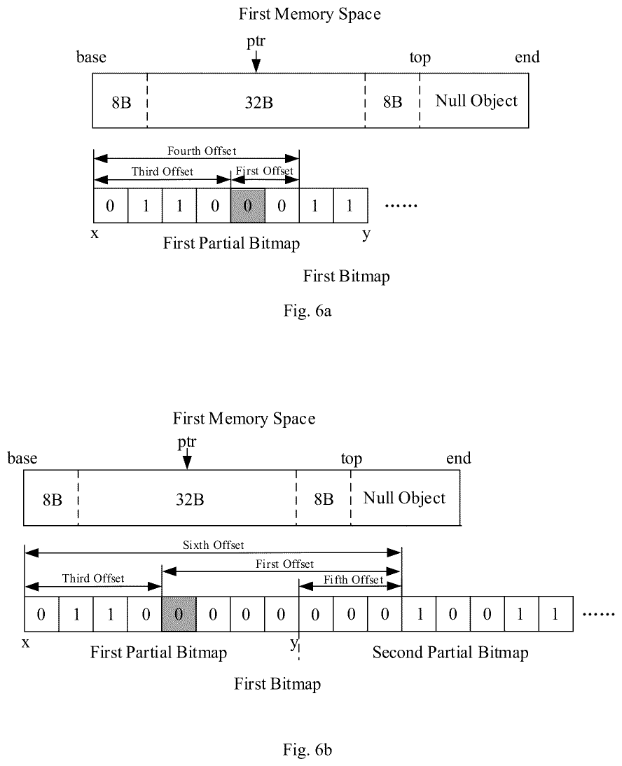

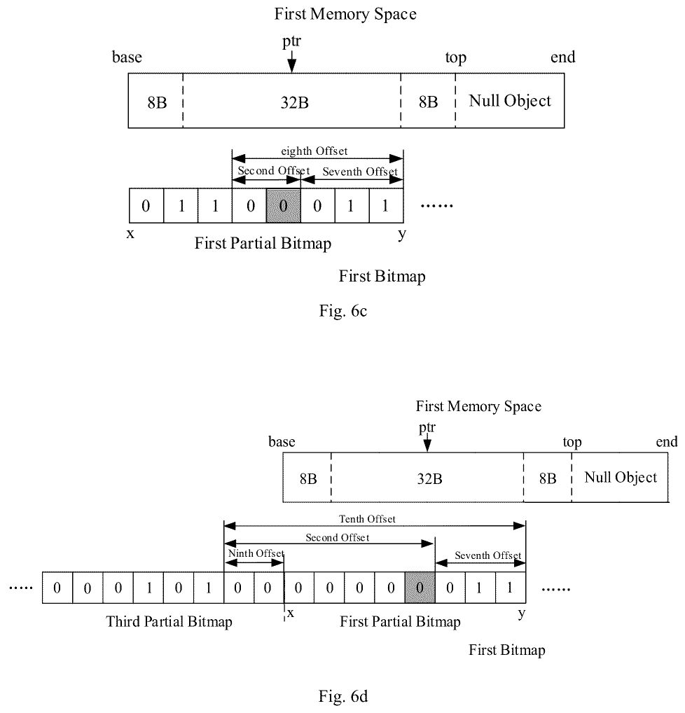

For example, for FIG. 6a, the preset number n=8, the pointer points to the 30th byte in the first memory space (in which the starting address is base, the ending address is end, assuming base=0), that is, the address of the pointer is ptr=(30)₁₀=(11110)₂, and the address of the first byte of the 8 bytes where the pointer is located is p=(24)₁₀=(11000)₂ (in which the lower log₂8 bits of ptr are cleared to zero), and the position of the first bit in the first bitmap index=(ptr−base)/n=3 (rounded). Assuming that the address of the first bitmap is from x to y, where the address of the first partial bitmap bytep=x+(index/8)=x, the position of the first bit in the first partial bitmap=index % 8=3% 8=3, and the first mask is constructed as mask1=1<<(index %8)=1<<(3%8)=1<<3=00001000.

Further, in the first mask, a number of 0s that exist in the direction from 1 towards the tail of the first mask, that is, the number of 0s to the left of 1, is determined, and it is determined as the third offset for the first bit relative to the tail of the first partial bitmap. This can be realized by a preset instruction leadingZeros(a) in the CPU, where leadingZeros(a) is to calculate a number of consecutive 0s form the beginning of a, so the third offset=leadingZeros(mask1)=4.

The determining whether the second bit exists in the first partial bitmap, may specifically include:
constructing a second mask, in which the length of the second mask is the same as that of the first partial bitmap, and positions of a preset number of bits in the tail of the second mask are 0, the remaining positions are 1, and the preset number is the third offset.

In the above example, the second mask mask2=00001111 may be derived as follows: mask2=0xFF>>“third offset”=00001111 (i.e., 1111111 is shifted to the right by “third offset”).

Further, a bitwise AND operation is performed on the second mask and the first partial bitmap, and the operation result bt=*bytep & mask2=01100011 & 00001111=00000011. If the operation result bt is not 0, it means that the second bit exists in the first partial bitmap, and the first 1 in the tail of the operation result bt corresponds to the position of the second bit; or if the operation result bt is 0, it means that the second bit does not exist in the first partial bitmap.

If the operation result bt is not 0, a number of 0s that exist in the tail of the operation result bt, that is, the number of 0s that exist from the second bit towards the tail of the operation result, may be determined, as the fourth offset. The fourth offset=leadingZeros(bt)=6. In turn, the first offset between the first bit and the second bit=“fourth offset”−“third offset”=6−4=2.

If the operation result bt is 0, as illustrated in FIG. 6b, a part of the bitmap corresponding to an adjacent byte is read along the head direction (to the right), and then it is judged whether the part of the bitmap is 0. If it is determined that the part of the bitmap is not 0, the part of the bitmap is denoted as a second partial bitmap, and it is determined that the second bit exists in the second partial bitmap. In turn, a number of 0s that exist in the tail of the second partial bitmap may determined as the fifth offset for the second bit relative to the tail of the second partial bitmap. The number of bits between the tail of the second partial bitmap and the tail of the first partial bitmap is 8. The fifth offset may be added to the number of bits (i.e., “fifth offset”+8) to get the sixth offset for the second bit relative to the tail of the first partial bitmap. In turn, the first offset between the first bit and the second bit=“sixth offset”−“third offset”

If it is determined that the part of the bitmap corresponding to the adjacent byte is 0, a part of the bitmap corresponding to the next adjacent byte is continued to be read along the head direction (to the right). If it is determined that the part of the bitmap is not 0, the part of the bitmap is denoted as a second partial bitmap. Likewise, a number of 0s that exist in the tail of the second partial bitmap may be determined as the fifth offset for the second bit relative to the tail of the second partial bitmap. The number of bits between the tail of the second partial bitmap and the tail of the first partial bitmap is 8*2 (i.e., 2 bytes). The fifth offset is added to the number of bits (i.e., “fifth offset”+8*2) to get the offset for the second bit relative to the tail of the first partial bitmap, by which the third offset is subtracted to get the first offset between the first bit and the second bit. By analogy, it will not be detailed here.

On the basis of the above-described embodiments, the searching for a third bit with a value of 1 that is nearest to the first bit in the tail direction in the first bitmap, and determining a second offset between the first bit and the third bit, includes:
determining a seventh offset for the first bit relative to the head of the first partial bitmap;
determining whether the third bit exists in the first partial bitmap;
determining, if it is determined that the third bit exists in the first partial bitmap, an eighth offset for the third bit relative to the head of the first partial bitmap; determining the second offset between the first bit and the third bit according to the seventh offset and the eighth offset; or
reading, if it is determined that the third bit does not exist in the first partial bitmap, a part of the bitmap corresponding to a neighboring byte sequentially along the tail direction, until a third partial bitmap where the third bit exists is found, and determining a ninth offset for the third bit relative to the head of the third partial bitmap; determining a tenth offset for the third bit relative to the head of the first partial bitmap according to the ninth offset; determining the second offset between the first bit and the third bit according to the seventh offset and the tenth offset.

In this embodiment, after determining the first bit in the first partial bitmap, a seventh offset for the first bit relative to the head of the first partial bitmap, that is, the number of bits present between the first bit and the head of the first partial bitmap, may be determined, in which the concepts of the head and the tail of the first partial bit are the same as those in the above embodiment.

Likewise, since the memory of the object may be relatively large, spanning multiple bytes in the first bitmap, the third bit in the tail direction of the first bit in the first bitmap may be or may not be in the first partial bitmap. Therefore it is further required to judge whether the third bit exist in the first partial bitmap. If it is determined that the third bit exist in the first partial bitmap, an eighth offset for the third bit from the head of the first partial bitmap, that is, the number of bits present between the third bit and the head of the first partial bitmap, may be determined. The second offset between the first bit and the third bit may be derived by subtracting the seventh offset from the eighth offset. If it is determined that the third bit does not exist in the first partial bitmap, a part of the bitmap corresponding to an adjacent byte is read sequentially along the tail direction. Likewise, it is required to judge whether the third bit exists in the part of the bitmap corresponding to the adjacent byte sequentially. If the third bit does not exist in the part of the bitmap corresponding to the first adjacent byte, a part of the bitmap corresponding to the next adjacent byte is continued to be read, and so on, until a part of the bitmap where the third bit exists is found, which is denoted as a third partial bitmap. Then, a ninth offset for the third bit relative to the head of the third partial bitmap may be further determined. Since the seventh offset takes the head of the first partial bitmap as reference, and the ninth offset takes the head of the third partial bitmap as reference, it is required to make a conversion to cause the ninth offset to take the head of the first partial bitmap as reference, so that a tenth offset for the third bit relative to the head of the first partial bitmap may be derived. As such, the second offset between the first bit and the third bit may be derived by subtracting the seventh offset from the tenth offset. Specifically, when determining the tenth offset, the number of bits between the head of the third partial bitmap and the head of the first partial bitmap may be acquired, and the ninth offset may be added to the number of bits to get the tenth offset.

On the basis of the above embodiment, the above process of determining the offset can be realized by means of bit operation, the specific process of which is as follows.

As illustrated in FIG. 6c, in the above example, the first mask is constructed as mask1=00001000 (if the first mask has been constructed before, there is no need to construct repetitively here). In the first mask, a number of 0s that exist in the direction from 1 towards the head of the first mask, that is, the number of 0s on the right side of 1, may be determined as the seventh offset for the first bit relative to the head of the first partial bitmap. This can be realized by a preset instruction trailingZeros(a) in the CPU, where trailingZeros(a) is to calculate a number of consecutive 0s in the ending of a, so the seventh offset=trailingZeros(mask1)=3.

The determining whether the third bit exists in the first partial bitmap, may specifically include:
constructing a third mask, in which the length of the third mask is the same as that of the first partial bitmap, and positions of a preset number of bits in the head of the third mask are 0, the remaining positions are 1, and the preset number is the seventh offset plus 1.

In the above example, the third mask mask3=11110000 may be derived as follows: mask3=0xFF<<(“seventh offset”+1)=11110000 (i.e., 11111111 is shifted to the left by “seventh offset”+1).

Further, a bitwise AND operation is performed on the third mask and the first partial bitmap, and the operation result bt=*bytep & mask3=01100011 & 11110000=01100000. If the operation result bt is not 0, it means that the third bit exists in the first partial bitmap, and the first 1 in the head of the operation result bt corresponds to the position of the third bit; or if the operation result bt is 0, it means that the third bit does not exist in the first partial bitmap.

If the operation result bt is not 0, a number of 0s that exist in the head of the operation result bt, that is, the number of 0s that exist from the third bit towards the head of the operation result, may be determined as the eighth offset. The eighth offset=trailingZeros (bt)=5. In turn, the second offset between the first bit and the third bit=“eighth offset”−“seventh offset”=5−3=2.

If the operation result bt is 0, as illustrated in FIG. 6d, a part of the bitmap corresponding to an adjacent byte is read along the tail direction (to the left), and it is judged whether the part of the bitmap is 0. If it is determined that the part of the bitmap is not 0, the part of the bitmap is denoted as a third partial bitmap, and it is determined that the third bit exists in the third partial bitmap. In turn, a number of 0s that exist in the head of the third partial bitmap may be determined as the ninth offset for the third bit relative to the head of the third partial bitmap. The number of bits between the head of the third partial bitmap and the head of the first partial bitmap is 8. The ninth offset is added to the number of bits (i.e., “ninth offset”+8) to get the tenth offset for the third bit relative to the head of the first partial bitmap. In turn, the second offset between the first bit and the third bit=“tenth offset”−“seventh offset”.

If it is determined that the part of the bitmap corresponding to the adjacent byte is 0, a part of the bitmap corresponding to the next adjacent byte is continued to be read along the tail direction (to the left). If it is determined that the part of the bitmap is not 0, the part of the bitmap is denoted as a third partial bitmap. Likewise, a number of 0s that exist in the head of the third partial bitmap may be determined as the ninth offset for the third bit relative to the head of the third partial bitmap. The number of bits between the head of the third partial bitmap and the head of the first partial bitmap is 8*2 (i.e., 2 bytes). The ninth offset is added to the number of bits (i.e., “ninth offset”+8*2) to get the offset for the third bit relative to the head of the first partial bitmap, by which the seventh offset is subtracted to get the second offset between the first bit and the third bit. By analogy, it will not be detailed here.

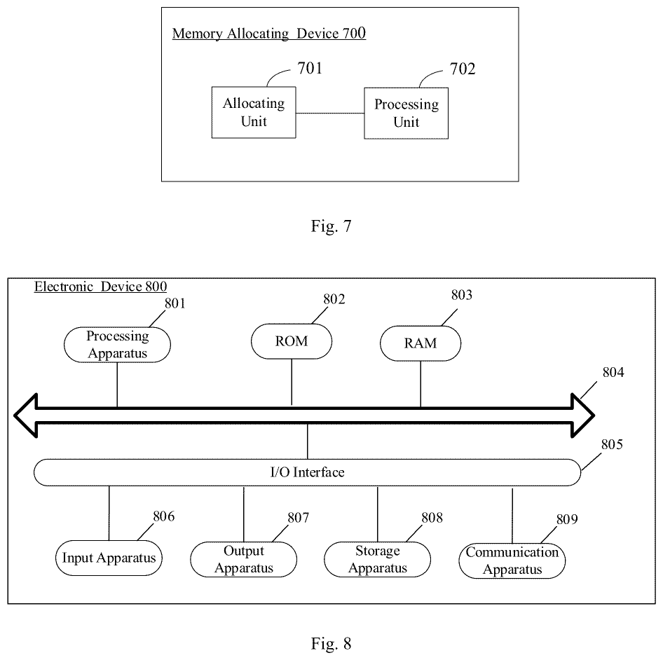

In correspondence to the memory allocating method of the above embodiments, FIG. 7 is a structural block diagram of a memory allocating device provided by an embodiment of the present disclosure. For convenience of illustration, only the parts that are related to the embodiments of the present disclosure are shown. Referring to FIG. 7, the memory allocating device 700 includes an allocating unit 701 and a processing unit 702.

The allocating unit 701 is used to allocate a first memory space of a preset size to a first thread to be allocated memory, and configure a first bitmap having a mapping relationship with the first memory space; and consecutively allocate memory in the first memory space according to a size of each of objects to be allocated memory in the first thread.

The processing unit 702 is used to identify a memory starting address of each of the objects in the first bitmap based on the mapping relationship.

In one or more embodiments of the present disclosure, the mapping relationship is that each bit in the first bitmap sequentially corresponds to a preset number of bytes in the first memory space.

The allocating unit 701 is used to, when consecutively allocating memory in the first memory space according to a size of each of objects to be allocated memory in the first thread, clear all bits of the first bitmap to zero; consecutively allocate memory in the first memory space according to the size of each of the objects to be allocated memory in the first thread. The memory size of each object is a multiple of the preset number.

The processing unit 702 is used to, when identifying a memory starting address of each of the objects in the first bitmap based on the mapping relationship, set a bit in the first bitmap corresponding to the memory starting address of each of the objects to 1.

In one or more embodiments of the present disclosure, the allocating unit 701, when consecutively allocating memory in the first memory space according to the size of each of the objects to be allocated memory in the first thread, is used to:
determine, before allocating memory to any one of the objects, whether unused memory of the first memory space meets the size of the object; and
allocate, when the unused memory of the first memory space meets the size of the object, memory from a starting address of the unused memory according to the size of the object.

In one or more embodiments of the present disclosure, the allocating unit 701 is further used to: set, when the unused memory of the first memory space does not meet the size of the object, a bit in the first bitmap corresponding to the starting address of the unused memory to 1, reallocate a second memory space of a preset size, and configuring a second bitmap having a mapping relationship with the second memory space; and consecutively allocate memory in the second memory space according to the size of each of the objects to be allocated memory in the first thread.

The processing unit 702 is further used to identify a memory starting address of each of the objects in the second bitmap based on the mapping relationship.

In one or more embodiments of the present disclosure, the processing unit 702 is further used to:
determine an address of a pointer pointing into a memory range of any target object in the first memory space; and
determine metadata of the target object according to the address of the pointer and the first bitmap. The metadata comprises at least one of a memory starting address, a memory ending address, and a memory size.

In one or more embodiments of the present disclosure, the processing unit 702, when determining metadata of the target object according to the address of the pointer and the first bitmap, is used to:
determine the first bit in the first bitmap corresponding to the address of the pointer;
search for the second bit having a value of 1 that is nearest to the first bit in a head direction in the first bitmap, determining a first offset between the first bit and the second bit, determine a first memory offset between a memory starting address of the target object and the address of the pointer according to the first offset and the preset number; and determine the memory starting address of the target object according to the address of the pointer and the first memory offset; and/or
search for a third bit having a value of 1 that is nearest to the first bit in a tail direction in the first bitmap, determine a second offset between the first bit and the third bit, determine a second memory offset between a memory ending address of the target object and the address of the pointer according to the second offset and the preset number; and determine the memory ending address of the target object according to the address of the pointer and the second memory offset; and/or
determine a memory size of the target object according to the memory starting address of the target object and the memory ending address of the target object.

In one or more embodiments of the present disclosure, the processing unit 702, when determining the first bit in the first bitmap corresponding to the address of the pointer, is used to:
determine a byte where the first bit is located in the first bitmap, read the first partial bitmap correspond to the byte, and determine the first bit in the first partial bitmap.

In one or more embodiments of the present disclosure, the processing unit 702, when searching for the second bit having a value of 1 that is nearest to the first bit in a head direction in the first bitmap, and determining the first offset between the first bit and the second bit, is used to:
determine the third offset for the first bit relative to a tail of the first partial bitmap;
determine whether the second bit exists in the first partial bitmap;
determine, when it is determined that the second bit exists in the first partial bitmap, a fourth offset for the second bit relative to the tail of the first partial bitmap; determine the first offset between the first bit and the second bit according to the third offset and the fourth offset; or
read, when it is determined that the second bit does not exist in the first partial bitmap, a part of the bitmap corresponding to a neighboring byte sequentially along the head direction, until a second partial bitmap where the second bit exists is found, and determine the fifth offset for the second bit relative to the tail of the second partial bitmap; determine the sixth offset for the second bit relative to the tail of the first partial bitmap according to the fifth offset; and determine the first offset between the first bit and the second bit according to the third offset and the sixth offset.

In one or more embodiments of the present disclosure, the processing unit 702, when searching for a third bit having a value of 1 that is nearest to the first bit in the tail direction in the first bitmap, and determining a second offset between the first bit and the third bit, is used to:
determine the seventh offset for the first bit relative to the head of the first partial bitmap;
determine whether the third bit exists in the first partial bitmap;
determine, when it is determined that the third bit exists in the first partial bitmap, an eighth offset for the third bit relative to the head of the first partial bitmap; and determine the second offset between the first bit and the third bit according to the seventh offset and the eighth offset; or
read, when it is determined that the third bit does not exist in the first partial bitmap, a part of the bitmap corresponding to a neighboring byte sequentially along the tail direction, until a third partial bitmap where the third bit exists is found, and determine a ninth offset for the third bit relative to the head of the third partial bitmap; determine a tenth offset for the third bit relative to the head of the first partial bitmap according to the ninth offset; and determine the second offset between the first bit and the third bit according to the seventh offset and the tenth offset.

In one or more embodiments of the present disclosure, the processing unit 702, after determining the first bit in the first partial bitmap, is used to:
construct the first mask according to a position of the first bit in the first partial bitmap, in which a length of the first mask is same as a length of the first partial bitmap, the position corresponding to the first bit is 1, and the remaining positions are 0.

In one or more embodiments of the present disclosure, the processing unit 702, when determining a third offset for the first bit relative to a tail of the first partial bitmap, is used to:
determine, in the first mask, a number of 0s that exist in a direction from 1 towards the tail of the first mask as the third offset.

In one or more embodiments of the present disclosure, the processing unit 702, when determining whether the second bit exists in the first partial bitmap, is used to:
construct the second mask, in which a length of the second mask is same as a length of the first partial bitmap, and positions of a preset number of bits in the tail of the second mask are 0, the remaining positions are 1, and the preset number is the third offset;
perform a bitwise AND operation on the second mask and the first partial bitmap, and determine, when a result of the operation is not 0, that the second bit exists in the first partial bitmap; or determine, when the result of the operation is 0, that the second bit does not exist in the first partial bitmap;
correspondingly, the processing unit 702, when determining the fourth offset for the second bit relative to the tail of the first partial bitmap, is used to:
determine a number of 0s that exist in the tail of the result of the operation as the fourth offset.

In one or more embodiments of the present disclosure, the processing unit 702, when determining that the second bit exists in the second partial bitmap, and then determining the fifth offset for the second bit relative to the tail of the second partial bitmap, is used to:
determine, when it is determined that the second partial bitmap is not 0, that the second bit exists in the second partial bitmap;
determine the number of 0s in the tail of the second partial bitmap as the fifth offset;
correspondingly, the processing unit 702, when determining the sixth offset for the second bit relative to the tail of the first partial bitmap according to the fifth offset, is used to:
acquire the number of bits between the tail of the second partial bitmap and the tail of the first partial bitmap; and
add the fifth offset and the number of bits to obtain t the sixth offset.

In one or more embodiments of the present disclosure, the processing unit 702, when determining the seventh offset for the first bit relative to the head of the first partial bitmap, is used to:
determine, in the first mask, the number of 0s that exist in a direction from 1 towards the head of the first mask as the seventh offset.

In one or more embodiments of the present disclosure, the processing unit 702, when determining whether the third bit exists in the first partial bitmap, is used to:
construct the third mask, in which a length of the third mask is same as a length of the first partial bitmap, and positions of a preset number of bits in the head of the third mask are 0, the remaining positions are 1, and the preset number is the seventh offset plus 1;
perform a bitwise AND operation on the third mask and the first partial bitmap, and determine, when the result of the operation is not 0, that the third bit exists in the first partial bitmap; or determine, when the result of the operation is 0, that the third bit does not exist in the first partial bitmap;
correspondingly, the processing unit 702, when determining the eighth offset for the third bit relative to the head of the first partial bitmap, is used to:
determine the number of 0s that exist in the head of the result of the operation as the eighth offset.

In one or more embodiments of the present disclosure, the processing unit 702, when determining that the third bit exists in the third partial bitmap, and then determining the ninth offset for the third bit relative to the head of the third partial bitmap, is used to:
determine, when it is determined that the third partial bitmap is not 0, that the third bit exists in the third partial bitmap;
determine the number of 0s that exist in the head of the third partial bitmap as the ninth offset;
correspondingly, the processing unit 702, when determining the tenth offset for the third bit relative to the head of the first partial bitmap according to the ninth offset, is used to:
acquire the number of bits between the head of the third partial bitmap and the head of the first partial bitmap; and
add the ninth offset and the number of bits to obtain the tenth offset.

The device provided in the present embodiment can be used to execute the technical solution of the above method embodiment, and the realization principle and technical effects thereof are similar, so the present embodiment would not repeat here.

Referring to FIG. 8, and it shows the structure schematic diagram suitable for achieving the electronic device 800 in the embodiment of the present disclosure. The electronic device 800 in the embodiment of the present disclosure may include but not be limited to a mobile terminal such as a mobile phone, a notebook computer, a digital broadcasting receiver, a Personal Digital Assistant (PDA), a Portable Android Device (PAD), a Portable Media Player (PMP), a vehicle terminal (such as a vehicle navigation terminal), and a fixed terminal such as a digital television (TV) and a desktop computer. The electronic device illustrated in FIG. 8 is only an example and should not impose any limitations on the functions and use scopes of the embodiments of the present disclosure.

As illustrated in FIG. 8, the electronic device 800 may include a processing apparatus (such as a central processing unit, and a graphics processor) 801, it may execute various appropriate actions and processes according to a program stored in a read-only memory (ROM) 802 or a program loaded from a storage apparatus 808 to a random access memory (RAM) 803. In RAM 803, various programs and data required for operations of the electronic device 800 are also stored. The processing apparatus 801, ROM 802, and RAM 803 are connected to each other by a bus 804. An input/output (I/O) interface 805 is also connected to the bus 804.

Typically, the following apparatuses may be connected to the I/O interface 805: an input apparatus 806 such as a touch screen, a touchpad, a keyboard, a mouse, a camera, a microphone, an accelerometer, and a gyroscope; an output apparatus 807 such as a liquid crystal display (LCD), a loudspeaker, and a vibrator; a storage apparatus 808 such as a magnetic tape, and a hard disk drive; and a communication apparatus 809. The communication apparatus 809 may allow the electronic device 800 to wireless-communicate or wire-communicate with other devices so as to exchange data. Although FIG. 8 shows the electronic device 800 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method illustrated in the flow diagram. In such an embodiment, the computer program may be downloaded and installed from the network by the communication apparatus 809, or installed from the storage apparatus 808, or installed from ROM 802. When the computer program is executed by the processing apparatus 801, the above functions defined in the method in the embodiments of the present disclosure are executed.

It is noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a compact disk-read only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the method described in the above-described embodiments.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks illustrated in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances, for example, the first acquisition module can also be described as “a module that acquires at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, compact disk-read only memory (CD-ROM), optical storage device, magnetic storage device, or any suitable combination of the foregoing.

In the first aspect, the embodiments of the present disclosure provide a memory allocating method, which includes:
allocating the first memory space of a preset size to a first thread to be allocated memory, and configuring a first bitmap having a mapping relationship with the first memory space; and
consecutively allocating memory in the first memory space according to a size of each of objects to be allocated memory in the first thread, and identifying a memory starting address of each of the objects in the first bitmap based on the mapping relationship.

In one or more embodiments of the present disclosure, the mapping relationship is that each bit in the first bitmap sequentially corresponds to a preset number of bytes in the first memory space; and
correspondingly, the consecutively allocating memory in the first memory space according to a size of each of objects to be allocated memory in the first thread, and identifying a memory starting address of each of the objects in the first bitmap based on the mapping relationship, includes:
clearing all bits of the first bitmap to zero;
consecutively allocating memory in the first memory space according to the size of each of the objects to be allocated memory in the first thread, in which a memory size of each object is a multiple of the preset number; and setting a bit in the first bitmap corresponding to the memory starting address of
each of the objects to 1.

According to one or more embodiments of the present disclosure, the consecutively allocating memory in the first memory space according to the size of each of the objects to be allocated memory in the first thread, comprises:
determining, before allocating memory to any one of the objects, whether unused memory of the first memory space meets the size of the object; and
allocating, when the unused memory of the first memory space meets the size of the object, memory from a starting address of the unused memory according to the size of the object.

According to one or more embodiments of the present disclosure, the method further includes:
setting, when the unused memory of the first memory space does not meet the size of the object, a bit in the first bitmap corresponding to the starting address of the unused memory to 1, reallocating a second memory space of a preset size, and configuring a second bitmap having a mapping relationship with the second memory space; and
consecutively allocating memory in the second memory space according to the size of each of the objects to be allocated memory in the first thread, and identifying a memory starting address of each of the objects in the second bitmap based on the mapping relationship.

According to one or more embodiments of the present disclosure, the method further includes:
determining an address of a pointer pointing into a memory range of any target object in the first memory space; and
determining metadata of the target object according to the address of the pointer and the first bitmap, in which the metadata comprises at least one of a memory starting address, a memory ending address, and a memory size.

According to one or more embodiments of the present disclosure, the determining metadata of the target object according to the address of the pointer and the first bitmap, comprises:
determining a first bit in the first bitmap corresponding to the address of the pointer;
searching for a second bit having a value of 1 that is nearest to the first bit in a head direction in the first bitmap, determining a first offset between the first bit and the second bit, determining a first memory offset between a memory starting address of the target object and the address of the pointer according to the first offset and the preset number; and determining the memory starting address of the target object according to the address of the pointer and the first memory offset; and/or
searching for a third bit having a value of 1 that is nearest to the first bit in a tail direction in the first bitmap, determining a second offset between the first bit and the third bit, determining a second memory offset between a memory ending address of the target object and the address of the pointer according to the second offset and the preset number; and determining the memory ending address of the target object according to the address of the pointer and the second memory offset; and/or
determining a memory size of the target object according to the memory starting address of the target object and the memory ending address of the target object.

According to one or more embodiments of the present disclosure, the determining a first bit in the first bitmap corresponding to the address of the pointer, comprises:
determining a byte where the first bit is located in the first bitmap, reading a first partial bitmap correspond to the byte, and determining the first bit in the first partial bitmap.

According to one or more embodiments of the present disclosure, the searching for a second bit having a value of 1 that is nearest to the first bit in a head direction in the first bitmap, and determining a first offset between the first bit and the second bit, comprises:
determining a third offset for the first bit relative to a tail of the first partial bitmap;
determining whether the second bit exists in the first partial bitmap;
determining, when it is determined that the second bit exists in the first partial bitmap, a fourth offset for the second bit relative to the tail of the first partial bitmap; determining the first offset between the first bit and the second bit according to the third offset and the fourth offset; or
reading, when it is determined that the second bit does not exist in the first partial bitmap, a part of the bitmap corresponding to a neighboring byte sequentially along the head direction, until a second partial bitmap where the second bit exists is found, and determining a fifth offset for the second bit relative to the tail of the second partial bitmap; determining a sixth offset for the second bit relative to the tail of the first partial bitmap according to the fifth offset; determining the first offset between the first bit and the second bit according to the third offset and the sixth offset.

According to one or more embodiments of the present disclosure, the searching for a third bit having a value of 1 that is nearest to the first bit in the tail direction in the first bitmap, and determining a second offset between the first bit and the third bit, comprises:
determining a seventh offset for the first bit relative to the head of the first partial bitmap;
determining whether the third bit exists in the first partial bitmap;
determining, when it is determined that the third bit exists in the first partial bitmap, an eighth offset for the third bit relative to the head of the first partial bitmap; and determining the second offset between the first bit and the third bit according to the seventh offset and the eighth offset; or
reading, when it is determined that the third bit does not exist in the first partial bitmap, a part of the bitmap corresponding to a neighboring byte sequentially along the tail direction, until a third partial bitmap where the third bit exists is found, and determining a ninth offset for the third bit relative to the head of the third partial bitmap; determining a tenth offset for the third bit relative to the head of the first partial bitmap according to the ninth offset; and determining the second offset between the first bit and the third bit according to the seventh offset and the tenth offset.

According to one or more embodiments of the present disclosure, the method, after determining the first bit in the first partial bitmap, further includes:
constructing a first mask according to a position of the first bit in the first partial bitmap, in which a length of the first mask is same as a length of the first partial bitmap, the position corresponding to the first bit is 1, and the remaining positions are 0.

According to one or more embodiments of the present disclosure, the determining a third offset for the first bit relative to a tail of the first partial bitmap, comprises:
determining, in the first mask, a number of 0s that exist in a direction from 1 towards the tail of the first mask as the third offset.

According to one or more embodiments of the present disclosure, the determining whether the second bit exists in the first partial bitmap, comprises:
constructing a second mask, in which a length of the second mask is same as a length of the first partial bitmap, and positions of a preset number of bits in the tail of the second mask are 0, the remaining positions are 1, and the preset number is the third offset;
performing a bitwise AND operation on the second mask and the first partial bitmap, and determining, when a result of the operation is not 0, that the second bit exists in the first partial bitmap; or determining, when the result of the operation is 0, that the second bit does not exist in the first partial bitmap;
correspondingly, the determining a fourth offset for the second bit relative to the tail of the first partial bitmap, comprises:
determining a number of 0s that exist in the tail of the result of the operation as the fourth offset.

According to one or more embodiments of the present disclosure, the determining that the second bit exists in the second partial bitmap, and then determining the fifth offset for the second bit relative to the tail of the second partial bitmap, comprises:
determining, when it is determined that the second partial bitmap is not 0, that the second bit exists in the second partial bitmap;
determining a number of 0s in the tail of the second partial bitmap as the fifth offset;
correspondingly, the determining a sixth offset for the second bit relative to the tail of the first partial bitmap according to the fifth offset, comprises:
acquiring a number of bits between the tail of the second partial bitmap and the tail of the first partial bitmap;
adding the fifth offset and the number of bits to obtain t the sixth offset.

According to one or more embodiments of the present disclosure, the determining a seventh offset for the first bit relative to the head of the first partial bitmap, comprises:
determining, in the first mask, a number of 0s that exist in a direction from 1 towards the head of the first mask as the seventh offset.

According to one or more embodiments of the present disclosure, the determining whether the third bit exists in the first partial bitmap, comprises:
constructing a third mask, in which a length of the third mask is same as a length of the first partial bitmap, and positions of a preset number of bits in the head of the third mask are 0, the remaining positions are 1, and the preset number is the seventh offset plus 1;
performing a bitwise AND operation on the third mask and the first partial bitmap, and determining, when the result of the operation is not 0, that the third bit exists in the first partial bitmap; or determining, when the result of the operation is 0, that the third bit does not exist in the first partial bitmap;
correspondingly, the determining an eighth offset for the third bit relative to the head of the first partial bitmap, comprises:
determining a number of 0s that exist in the head of the result of the operation as the eighth offset.

According to one or more embodiments of the present disclosure, the determining that the third bit exists in the third partial bitmap, and then determining the ninth offset for the third bit relative to the head of the third partial bitmap, comprises:
determining, when it is determined that the third partial bitmap is not 0, that the third bit exists in the third partial bitmap;
determining a number of 0s that exist in the head of the third partial bitmap as the ninth offset;
correspondingly, the determining a tenth offset for the third bit relative to the head of the first partial bitmap according to the ninth offset, comprises:
acquiring a number of bits between the head of the third partial bitmap and the head of the first partial bitmap;
adding the ninth offset and the number of bits to obtain the tenth offset.

In the second aspect, the embodiments of the present disclosure provide a memory allocating device, which includes an allocating unit and a processing unit.

The allocating unit is used to allocate a first memory space of a preset size to a first thread to be allocated memory, and configure a first bitmap having a mapping relationship with the first memory space; and consecutively allocate memory in the first memory space according to a size of each of objects to be allocated memory in the first thread.

The processing unit is used to identify a memory starting address of each of the objects in the first bitmap based on the mapping relationship.

According to one or more embodiments of the present disclosure, the mapping relationship is that each bit in the first bitmap sequentially corresponds to a preset number of bytes in the first memory space.

The allocating unit is used to, when consecutively allocating memory in the first memory space according to a size of each of objects to be allocated memory in the first thread, clear all bits of the first bitmap to zero; consecutively allocate memory in the first memory space according to the size of each of the objects to be allocated memory in the first thread. The memory size of each object is a multiple of the preset number.

The processing unit is used to, when identifying a memory starting address of each of the objects in the first bitmap based on the mapping relationship, set a bit in the first bitmap corresponding to the memory starting address of each of the objects to 1.

According to one or more embodiments of the present disclosure, the allocating unit, when consecutively allocating memory in the first memory space according to the size of each of the objects to be allocated memory in the first thread, is used to:
determine, before allocating memory to any one of the objects, whether unused memory of the first memory space meets the size of the object; and
allocate, when the unused memory of the first memory space meets the size of the object, memory from a starting address of the unused memory according to the size of the object.

According to one or more embodiments of the present disclosure, the allocating unit is further used to: set, when the unused memory of the first memory space does not meet the size of the object, a bit in the first bitmap corresponding to the starting address of the unused memory to 1, reallocate a second memory space of a preset size, and configuring a second bitmap having a mapping relationship with the second memory space; and consecutively allocate memory in the second memory space according to the size of each of the objects to be allocated memory in the first thread.

The processing unit is further used to identify a memory starting address of each of the objects in the second bitmap based on the mapping relationship.

According to one or more embodiments of the present disclosure, the processing unit is further used to:
determine an address of a pointer pointing into a memory range of any target object in the first memory space; and
determine metadata of the target object according to the address of the pointer and the first bitmap. The metadata comprises at least one of a memory starting address, a memory ending address, and a memory size.

According to one or more embodiments of the present disclosure, the processing unit, when determining metadata of the target object according to the address of the pointer and the first bitmap, is used to:
determine the first bit in the first bitmap corresponding to the address of the pointer;
search for the second bit having a value of 1 that is nearest to the first bit in a head direction in the first bitmap, determining a first offset between the first bit and the second bit, determine a first memory offset between a memory starting address of the target object and the address of the pointer according to the first offset and the preset number; and determine the memory starting address of the target object according to the address of the pointer and the first memory offset; and/or
search for a third bit having a value of 1 that is nearest to the first bit in a tail direction in the first bitmap, determine a second offset between the first bit and the third bit, determine a second memory offset between a memory ending address of the target object and the address of the pointer according to the second offset and the preset number; and determine the memory ending address of the target object according to the address of the pointer and the second memory offset; and/or
determine a memory size of the target object according to the memory starting address of the target object and the memory ending address of the target object.

According to one or more embodiments of the present disclosure, the processing unit, when determining the first bit in the first bitmap corresponding to the address of the pointer, is used to:
determine a byte where the first bit is located in the first bitmap, read the first partial bitmap correspond to the byte, and determine the first bit in the first partial bitmap.

In one or more embodiments of the present disclosure, the processing unit, when searching for the second bit having a value of 1 that is nearest to the first bit in a head direction in the first bitmap, and determining the first offset between the first bit and the second bit, is used to:
determine the third offset for the first bit relative to a tail of the first partial bitmap;
determine whether the second bit exists in the first partial bitmap;
determine, when it is determined that the second bit exists in the first partial bitmap,
a fourth offset for the second bit relative to the tail of the first partial bitmap; determine the first offset between the first bit and the second bit according to the third offset and the fourth offset; or
read, when it is determined that the second bit does not exist in the first partial bitmap, a part of the bitmap corresponding to a neighboring byte sequentially along the head direction, until a second partial bitmap where the second bit exists is found, and determine the fifth offset for the second bit relative to the tail of the second partial bitmap; determine the sixth offset for the second bit relative to the tail of the first partial bitmap according to the fifth offset; and determine the first offset between the first bit and the second bit according to the third offset and the sixth offset.

According to one or more embodiments of the present disclosure, the processing unit, when searching for a third bit having a value of 1 that is nearest to the first bit in the tail direction in the first bitmap, and determining a second offset between the first bit and the third bit, is used to:
determine the seventh offset for the first bit relative to the head of the first partial bitmap;
determine whether the third bit exists in the first partial bitmap;
determine, when it is determined that the third bit exists in the first partial bitmap, an eighth offset for the third bit relative to the head of the first partial bitmap; and determine the second offset between the first bit and the third bit according to the seventh offset and the eighth offset; or
read, when it is determined that the third bit does not exist in the first partial bitmap, a part of the bitmap corresponding to a neighboring byte sequentially along the tail direction, until a third partial bitmap where the third bit exists is found, and determine a ninth offset for the third bit relative to the head of the third partial bitmap; determine a tenth offset for the third bit relative to the head of the first partial bitmap according to the ninth offset; and determine the second offset between the first bit and the third bit according to the seventh offset and the tenth offset.

According to one or more embodiments of the present disclosure, the processing unit, after determining the first bit in the first partial bitmap, is used to:
construct the first mask according to a position of the first bit in the first partial bitmap, in which a length of the first mask is same as a length of the first partial bitmap, the position corresponding to the first bit is 1, and the remaining positions are 0.

According to one or more embodiments of the present disclosure, the processing unit, when determining a third offset for the first bit relative to a tail of the first partial bitmap, is used to:
determine, in the first mask, a number of 0s that exist in a direction from 1 towards the tail of the first mask as the third offset.

According to one or more embodiments of the present disclosure, the processing unit, when determining whether the second bit exists in the first partial bitmap, is used to:
construct the second mask, in which a length of the second mask is same as a length of the first partial bitmap, and positions of a preset number of bits in the tail of the second mask are 0, the remaining positions are 1, and the preset number is the third offset;
perform a bitwise AND operation on the second mask and the first partial bitmap, and determine, when a result of the operation is not 0, that the second bit exists in the first partial bitmap; or determine, when the result of the operation is 0, that the second bit does not exist in the first partial bitmap;
correspondingly, the processing unit, when determining the fourth offset for the second bit relative to the tail of the first partial bitmap, is used to:
determine a number of 0s that exist in the tail of the result of the operation as the fourth offset.

According to one or more embodiments of the present disclosure, the processing unit, when determining that the second bit exists in the second partial bitmap, and then determining the fifth offset for the second bit relative to the tail of the second partial bitmap, is used to:
determine, when it is determined that the second partial bitmap is not 0, that the second bit exists in the second partial bitmap;
determine the number of 0s in the tail of the second partial bitmap as the fifth offset;
correspondingly, the processing unit, when determining the sixth offset for the second bit relative to the tail of the first partial bitmap according to the fifth offset, is used to:
acquire the number of bits between the tail of the second partial bitmap and the tail of the first partial bitmap; and
add the fifth offset and the number of bits to obtain t the sixth offset.

According to one or more embodiments of the present disclosure, the processing unit, when determining the seventh offset for the first bit relative to the head of the first partial bitmap, is used to:
determine, in the first mask, the number of 0s that exist in a direction from 1 towards the head of the first mask as the seventh offset.

According to one or more embodiments of the present disclosure, the processing unit, when determining whether the third bit exists in the first partial bitmap, is used to:
construct the third mask, in which a length of the third mask is same as a length of the first partial bitmap, and positions of a preset number of bits in the head of the third mask are 0, the remaining positions are 1, and the preset number is the seventh offset plus 1;
perform a bitwise AND operation on the third mask and the first partial bitmap, and determine, when the result of the operation is not 0, that the third bit exists in the first partial bitmap; or determine, when the result of the operation is 0, that the third bit does not exist in the first partial bitmap;
correspondingly, the processing unit, when determining the eighth offset for the third bit relative to the head of the first partial bitmap, is used to:
determine the number of 0s that exist in the head of the result of the operation as the eighth offset.

According to one or more embodiments of the present disclosure, the processing unit, when determining that the third bit exists in the third partial bitmap, and then determining the ninth offset for the third bit relative to the head of the third partial bitmap, is used to:
determine, when it is determined that the third partial bitmap is not 0, that the third bit exists in the third partial bitmap;
determine the number of 0s that exist in the head of the third partial bitmap as the ninth offset;
correspondingly, the processing unit, when determining the tenth offset for the third bit relative to the head of the first partial bitmap according to the ninth offset, is used to:
acquire the number of bits between the head of the third partial bitmap and the head of the first partial bitmap; and
add the ninth offset and the number of bits to obtain the tenth offset.

In the third aspect, the embodiments of the present disclosure provide an electronic device, which include: at least one processor and a memory.

The memory stores computer-executable instructions; and
the at least one processor executes the computer-executable instructions stored in the memory, causing the at least one processor to perform the memory allocating method in the first aspect.

In the fourth aspect, the embodiments of the present disclosure provide a computer-readable storage medium, and computer-executable instructions are stored in the computer readable storage medium. The computer-executable instructions, when executed by a processor, cause the processor to perform the memory allocating method in the first aspect.

In the fifth aspect, the embodiments of the present disclosure provide a computer program product which includes computer-executable instructions. The computer-executable instructions, when executed by a processor, cause the processor to perform the memory allocating method in the first aspect.

The above description is merely a preferred embodiment of the present disclosure and an illustration of the technical principles utilized. It should be understood by those skilled in the art that the scope of the disclosure involved in the present disclosure is not limited to a technical solution formed by a particular combination of the above-described technical features, but also covers other technical solutions formed by any combination of the above-described technical features or their equivalent without departing from the above-described disclosure concept. For example, a technical solution formed by interchanging the above-mentioned features with (but not limited to) technical features having similar functions disclosed in the present disclosure.

Furthermore, although the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of realizing the claims.

1. A memory allocating method, comprising:
allocating a first memory space of a preset size to a first thread to be allocated memory, and configuring a first bitmap having a mapping relationship with the first memory space; and
consecutively allocating memory in the first memory space according to a size of each of objects to be allocated memory in the first thread, and identifying a memory starting address of each of the objects in the first bitmap based on the mapping relationship.

2. The method according to claim 1, wherein the mapping relationship is that each bit in the first bitmap sequentially corresponds to a preset number of bytes in the first memory space; and
correspondingly, the consecutively allocating memory in the first memory space according to a size of each of objects to be allocated memory in the first thread, and identifying a memory starting address of each of the objects in the first bitmap based on the mapping relationship, comprises:
clearing all bits of the first bitmap to zero;
consecutively allocating memory in the first memory space according to the size of each of the objects to be allocated memory in the first thread, wherein a memory size of each object is a multiple of the preset number; and
setting a bit in the first bitmap corresponding to the memory starting address of each of the objects to 1.

3. The method according to claim 1, wherein the consecutively allocating memory in the first memory space according to the size of each of the objects to be allocated memory in the first thread, comprises:
determining, before allocating memory to any one of the objects, whether unused memory of the first memory space meets the size of the object; and
allocating, when the unused memory of the first memory space meets the size of the object, memory from a starting address of the unused memory according to the size of the object.

4. The method according to claim 3, further comprising:
setting, when the unused memory of the first memory space does not meet the size of the object, a bit in the first bitmap corresponding to the starting address of the unused memory to 1, reallocating a second memory space of a preset size, and configuring a second bitmap having a mapping relationship with the second memory space; and
consecutively allocating memory in the second memory space according to the size of each of the objects to be allocated memory in the first thread, and identifying a memory starting address of each of the objects in the second bitmap based on the mapping relationship.

5. The method according to claim 2, further comprising:
determining an address of a pointer pointing into a memory range of any target object in the first memory space; and
determining metadata of the target object according to the address of the pointer and the first bitmap, wherein the metadata comprises at least one of a memory starting address, a memory ending address, and a memory size.

6. The method according to claim 5, wherein the determining metadata of the target object according to the address of the pointer and the first bitmap, comprises:
determining a first bit in the first bitmap corresponding to the address of the pointer;
searching for a second bit having a value of 1 that is nearest to the first bit in a head direction in the first bitmap, determining a first offset between the first bit and the second bit, determining a first memory offset between a memory starting address of the target object and the address of the pointer according to the first offset and the preset number;
and determining the memory starting address of the target object according to the address of the pointer and the first memory offset; and/or
searching for a third bit having a value of 1 that is nearest to the first bit in a tail direction in the first bitmap, determining a second offset between the first bit and the third bit, determining a second memory offset between a memory ending address of the target object and the address of the pointer according to the second offset and the preset number; and
determining the memory ending address of the target object according to the address of the pointer and the second memory offset; and/or
determining a memory size of the target object according to the memory starting address of the target object and the memory ending address of the target object.

7. The method according to claim 6, wherein the determining a first bit in the first bitmap corresponding to the address of the pointer, comprises:
determining a byte where the first bit is located in the first bitmap, reading a first partial bitmap correspond to the byte, and determining the first bit in the first partial bitmap.

8. The method according to claim 7, wherein the searching for a second bit having a value of 1 that is nearest to the first bit in a head direction in the first bitmap, and determining a first offset between the first bit and the second bit, comprises:
determining a third offset for the first bit relative to a tail of the first partial bitmap;
determining whether the second bit exists in the first partial bitmap;
determining, when it is determined that the second bit exists in the first partial bitmap, a fourth offset for the second bit relative to the tail of the first partial bitmap; determining the first offset between the first bit and the second bit according to the third offset and the fourth offset; or
reading, when it is determined that the second bit does not exist in the first partial bitmap, a part of the bitmap corresponding to a neighboring byte sequentially along the head direction, until a second partial bitmap where the second bit exists is found, and determining a fifth offset for the second bit relative to the tail of the second partial bitmap;
determining a sixth offset for the second bit relative to the tail of the first partial bitmap according to the fifth offset; determining the first offset between the first bit and the second bit according to the third offset and the sixth offset.

9. The method according to claim 7, wherein the searching for a third bit having a value of 1 that is nearest to the first bit in the tail direction in the first bitmap, and determining a second offset between the first bit and the third bit, comprises:
determining a seventh offset for the first bit relative to the head of the first partial bitmap;
determining whether the third bit exists in the first partial bitmap;
determining, when it is determined that the third bit exists in the first partial bitmap, an eighth offset for the third bit relative to the head of the first partial bitmap; and determining the second offset between the first bit and the third bit according to the seventh offset and the eighth offset; or
reading, when it is determined that the third bit does not exist in the first partial bitmap, a part of the bitmap corresponding to a neighboring byte sequentially along the tail direction, until a third partial bitmap where the third bit exists is found, and determining a ninth offset for the third bit relative to the head of the third partial bitmap; determining a tenth offset for the third bit relative to the head of the first partial bitmap according to the ninth offset;
and determining the second offset between the first bit and the third bit according to the seventh offset and the tenth offset.

10. The method according to claim 8, further comprising, after determining the first bit in the first partial bitmap:
constructing a first mask according to a position of the first bit in the first partial bitmap, wherein a length of the first mask is same as a length of the first partial bitmap, the position corresponding to the first bit is 1, and the remaining positions are 0; and
the determining a third offset for the first bit relative to a tail of the first partial bitmap, comprises:
determining, in the first mask, a number of 0s that exist in a direction from 1 towards the tail of the first mask as the third offset.

11. The method according to claim 10, wherein the determining whether the second bit exists in the first partial bitmap, comprises:
constructing a second mask, wherein a length of the second mask is same as a length of the first partial bitmap, and positions of a preset number of bits in the tail of the second mask are 0, the remaining positions are 1, and the preset number is the third offset;
performing a bitwise AND operation on the second mask and the first partial bitmap, and determining, when a result of the operation is not 0, that the second bit exists in the first partial bitmap; or determining, when the result of the operation is 0, that the second bit does not exist in the first partial bitmap;
correspondingly, the determining a fourth offset for the second bit relative to the tail of the first partial bitmap, comprises:
determining a number of 0s that exist in the tail of the result of the operation as the fourth offset.

12. The method according to claim 11, wherein determining that the second bit exists in the second partial bitmap, and then determining the fifth offset for the second bit relative to the tail of the second partial bitmap, comprises:
determining, when it is determined that the second partial bitmap is not 0, that the second bit exists in the second partial bitmap;
determining a number of 0s in the tail of the second partial bitmap as the fifth offset;
correspondingly, the determining a sixth offset for the second bit relative to the tail of the first partial bitmap according to the fifth offset, comprises:
acquiring a number of bits between the tail of the second partial bitmap and the tail of the first partial bitmap;
adding the fifth offset and the number of bits to obtain t the sixth offset.

13. The method according to claim 9, further comprising, after determining the first bit in the first partial bitmap:
constructing a first mask according to a position of the first bit in the first partial bitmap, wherein a length of the first mask is same as a length of the first partial bitmap, the position corresponding to the first bit is 1, and the remaining positions are 0; and
the determining a seventh offset for the first bit relative to the head of the first partial bitmap, comprises:
determining, in the first mask, a number of 0s that exist in a direction from 1 towards the head of the first mask as the seventh offset.

14. The method according to claim 13, wherein the determining whether the third bit exists in the first partial bitmap, comprises:
constructing a third mask, wherein a length of the third mask is same as a length of the first partial bitmap, and positions of a preset number of bits in the head of the third mask are 0, the remaining positions are 1, and the preset number is the seventh offset plus 1;
performing a bitwise AND operation on the third mask and the first partial bitmap, and determining, when the result of the operation is not 0, that the third bit exists in the first partial bitmap; or determining, when the result of the operation is 0, that the third bit does not exist in the first partial bitmap;
correspondingly, the determining an eighth offset for the third bit relative to the head of the first partial bitmap, comprises:
determining a number of 0s that exist in the head of the result of the operation as the eighth offset.

15. The method according to claim 14, wherein determining that the third bit exists in the third partial bitmap, and then determining the ninth offset for the third bit relative to the head of the third partial bitmap, comprises:
determining, when it is determined that the third partial bitmap is not 0, that the third bit exists in the third partial bitmap;
determining a number of 0s that exist in the head of the third partial bitmap as the ninth offset;
correspondingly, the determining a tenth offset for the third bit relative to the head of the first partial bitmap according to the ninth offset, comprises:
acquiring a number of bits between the head of the third partial bitmap and the head of the first partial bitmap;
adding the ninth offset and the number of bits to obtain the tenth offset.

16. An electronic device, comprising: at least one processor and a memory;
wherein the memory stores computer-executable instructions; and
the at least one processor executes the computer-executable instructions stored in the memory to cause the at least one processor to:
allocate a first memory space of a preset size to a first thread to be allocated memory, and configure a first bitmap having a mapping relationship with the first memory space;
consecutively allocate memory in the first memory space according to a size of each of objects to be allocated memory in the first thread, and identify a memory starting address of each of the objects in the first bitmap based on the mapping relationship.

17. The electronic device according to claim 16, wherein the mapping relationship is that each bit in the first bitmap sequentially corresponds to a preset number of bytes in the first memory space; and
correspondingly, the at least one processor is further configured to:
clear all bits of the first bitmap to zero;
consecutively allocate memory in the first memory space according to the size of each of the objects to be allocated memory in the first thread, wherein a memory size of each object is a multiple of the preset number; and
set a bit in the first bitmap corresponding to the memory starting address of each of the objects to 1.

18. The electronic device according to claim 16, wherein the at least one processor is further configured to:
determine, before allocating memory to any one of the objects, whether unused memory of the first memory space meets the size of the object; and
allocate, when the unused memory of the first memory space meets the size of the object, memory from a starting address of the unused memory according to the size of the object.

19. The electronic device according to claim 18, wherein the at least one processor is further configured to:
set, when the unused memory of the first memory space does not meet the size of the object, a bit in the first bitmap corresponding to the starting address of the unused memory to 1, reallocate a second memory space of a preset size, and configure a second bitmap having a mapping relationship with the second memory space; and
consecutively allocate memory in the second memory space according to the size of each of the objects to be allocated memory in the first thread, and identify a memory starting address of each of the objects in the second bitmap based on the mapping relationship.

20. A computer-readable storage medium, wherein the computer-readable storage medium stores therein computer-executable instructions which, when executed by a processor, cause the processor to:
allocate a first memory space of a preset size to a first thread to be allocated memory, and configure a first bitmap having a mapping relationship with the first memory space; and
consecutively allocate memory in the first memory space according to a size of each of objects to be allocated memory in the first thread, and identify a memory starting address of each of the objects in the first bitmap based on the mapping relationship.
